(19) United States
(12) Patent Application Publication
(10) Pub. No.: US 2021/0125158 A1
(43) Pub. Date: Apr. 29, 2021

(54) BLOCKCHAIN CRYPTOCURRENCY TRANSMISSION METHOD USING BLOCKCHAIN SELF-AUTHENTICATION PROCESS

(71) Applicant: Ho Yun KYUNG, Seoul (KR)

(72) Inventor: Ho Yun KYUNG, Seoul (KR)

(21) Appl. No.: 17/254,979

(22) PCT Filed: Jun. 25, 2019
(86) PCT No.: PCT/KR2019/007681

§ 371 Date: Dec. 22, 2020

(30) Foreign Application Priority Data
Jun. 26, 2018 (KR) 10-2018-0073238

(51) Int. Cl. G06Q 20/06; G06Q 20/40; G06Q 20/38

(52) U.S. Cl. CPC G06Q 20/0655; G06Q 2220/00; G06Q 20/3829; G06Q 20/401

(57) ABSTRACT

A blockchain cryptocurrency transmission method according to the present invention transmits cryptocurrency on a cryptocurrency blockchain network using a self-authentication blockchain network and the cryptocurrency blockchain network. The blockchain cryptocurrency transmission method includes: a transmission reservation registration step (S100) of registering transmission reservation condition information, including a transmission target, a reservation date and time, a transmission amount, and a valid time for a remittance transaction, in the self-authentication blockchain network; a transmission processing request step (S300) of requesting processing of transmission from the cryptocurrency blockchain network to the self-authentication blockchain network; a transmission condition verification step (S400) of verifying transmission conditions using the transmission reservation condition information on the self-authentication blockchain network; and a remittance processing step (S500) of, when the transmission conditions are valid, processing the remittance transaction on the cryptocurrency blockchain network. The transmission reservation condition information is controllable by a user.

### TECHNICAL FIELD

The present invention relates to a blockchain cryptocurrency transmission method using a blockchain self-authentication process.

### BACKGROUND ART

As cryptocurrency transactions become an international and regular industry, they are increasing, and also damage caused by hacking is increasing accordingly. Most of the accidents are based on poor private key management or social engineering attacks. One reason for this is that private key management is difficult. However, fundamentally, the existing complexity-based encryption key method can be decrypted with better computing power. Although the encryption key method consumes a lot of resources for operation, it is not a structure that cannot be decrypted fundamentally. Accordingly, if sufficient computational power is provided, an encryption key is known as a resolvable object. In the future, a society in which quantum computers and cloud computing with large amounts of computing power can be easily rented and used is coming, and thus countermeasures against it are required.

If financial information is collected in a centralized manner as in the case of a cryptocurrency exchange, hacking based on internal collusion will not cease. As an alternative to the centralized exchange, a P2P decentralized exchange is being discussed. However, the P2P decentralized exchange has limitations to many large-scale transactions, so there are limitations in the applicability thereof.

In the blockchain field, the latest technologies such as atomic swap, zk-SNARKS, and lighting-based smart contracts enable secure transactions between parties without third-party intervention. However, this scheme has a disadvantage in that it is vulnerable to direct private key attacks. As a widely used technology for protecting secret keys, hardware wallets are mainly used by individuals, and a multisig method required to execute transactions is powerful enough to be used by exchanges.

However, both the cases exposed vulnerabilities. In the case of an attack on the hardware wallet, there was a case where a private key was stolen by injecting firmware causing overflow into a hardware security module (HSM) that protected the private key, thereby creating a backdoor. In the case of multisig, protection against this type of attack can be provided because it is necessary to simultaneously control one or more keys in different locations. However, in reality, exchange takeover accidents frequently occur due to internal collusion, which is a weakness of technology and people.

Recently, Multi-Party Computation, which has been actively discussed for application to blockchain, has emerged as a substitute for secret keys, but it is still in the stage of conceptual research and is a method that can be applied only to jointly owned assets.

### DISCLOSURE

### Technical Problem

The present application is intended to overcome the above-described problems, and provides a method that transparently discloses a record for the transmission of cryptocurrency so that genuine self-authentication without third party intervention can be performed at an address level.

### Technical Solution

A blockchain cryptocurrency transmission method according to the present invention is applied to a blockchain cryptocurrency transmission method for transmitting cryptocurrency on a cryptocurrency blockchain network by using a self-authentication blockchain network for self-authentication and the cryptocurrency blockchain network for transmission of cryptocurrency. The blockchain cryptocurrency transmission method includes: a transmission reservation registration step of registering transmission reservation condition information, including a transmission target, a reservation date and time, a transmission amount, and a valid time for a remittance transaction in which real cryptocurrency is transmitted, in the self-authentication blockchain network; a transmission processing request step of requesting processing of transmission from the cryptocurrency blockchain network to the self-authentication blockchain network; a transmission condition verification step of verifying transmission conditions using the transmission reservation condition information on the self-authentication blockchain network; and a remittance processing step of, when the transmission conditions are valid, processing the remittance transaction on the cryptocurrency blockchain network. The transmission reservation condition information is controllable by a user.

In an embodiment, the self-authentication blockchain network and the cryptocurrency blockchain network are the same type of blockchain networks.

In an embodiment, the self-authentication blockchain network and the cryptocurrency blockchain network are different types of blockchain networks.

In an embodiment, the self-authentication blockchain network includes a plurality of blockchain networks.

In an embodiment, the transmission reservation condition information registered at the transmission reservation registration step is inquired only by the owner of the cryptocurrency.

In an embodiment, the transmission reservation registration step, the transmission processing request step, and the transmission condition verification step are performed by a smart contract.

In an embodiment, a multisig configured to be activated by a plurality of user keys is applied to the smart contract.

In an embodiment, an emergency transmission function of transmitting the remaining amount to a registered emergency transmission address when a problem occurs during a remittance process is provided.

In an embodiment, controlling the transmission reservation condition information by the user includes canceling the remittance transaction corresponding to the transmission reservation condition information.

In an embodiment, the transmission reservation registration step, the transmission processing request step, the transmission condition verification step, and the remittance processing step are processed within the transaction by redesigning a blockchain protocol used in the cryptocurrency blockchain network.

In an embodiment, the operation protocol of the transmission reservation registration step, the transmission processing request step, the transmission condition verification step, and the remittance processing step is stored in a free storage space for the transaction to minimize protocol redesign and is extracted and used in accordance with modality.

### Advantageous Effects

Therefore, according to the present invention provided, first, regulatory agencies enforce blockchain self-authentication on cryptocurrency exchanges as a policy, and thus it is difficult to avoid the avoidance of liability for leaks without grounds for withdrawal, thereby reducing hacking accidents caused by the internal collusion of exchanges.

Second, details of withdrawal may be monitored like accounting books by requiring corporations of a predetermined or larger size to use self-authentication accounts.

Third, from a technical perspective, protection may be achieved at an address level while breaking away from a method depending only on a private key, and thus the burden of protecting the secret key is reduced. Accordingly, it may be possible to reduce the difficulty of managing a private key given to an individual.

Fourth, from a technical perspective, damage may be minimized by giving a user the opportunity to filter out all unintended withdrawals.

### DESCRIPTION OF DRAWINGS

FIG. 1 is a schematic diagram showing the configuration of a system that is applied to a blockchain cryptocurrency transmission method according to an embodiment of the present invention;

FIG. 2 is a flowchart showing a blockchain cryptocurrency transmission method according to an embodiment of the present invention;

FIG. 3 is a conceptual diagram showing a blockchain cryptocurrency transmission method according to another embodiment of the present invention;

FIG. 4 is a flowchart showing a blockchain cryptocurrency transmission method according to another embodiment of the present invention; and

FIG. 5 is a flowchart illustrating transmission condition verification in the blockchain cryptocurrency transmission method according to the embodiment of FIG. 2.

### MODE FOR INVENTION

1. The Overall Process

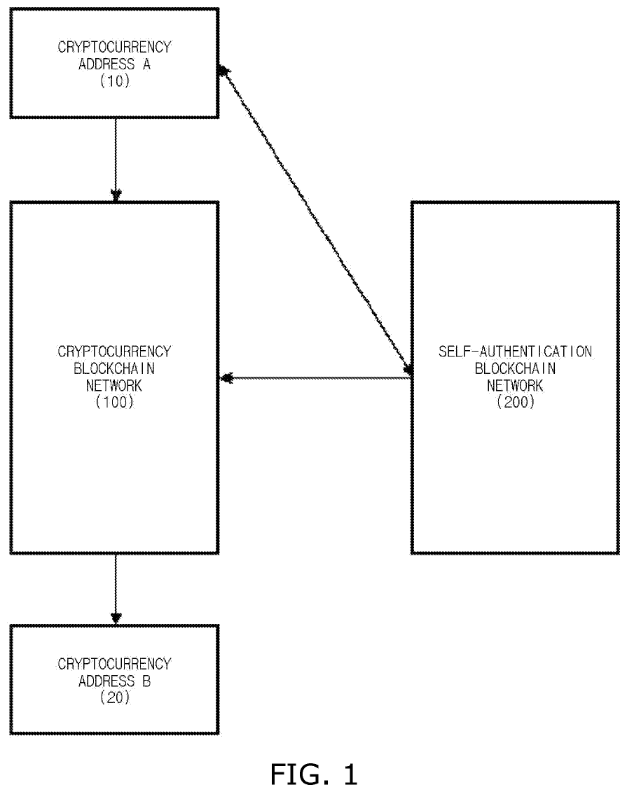

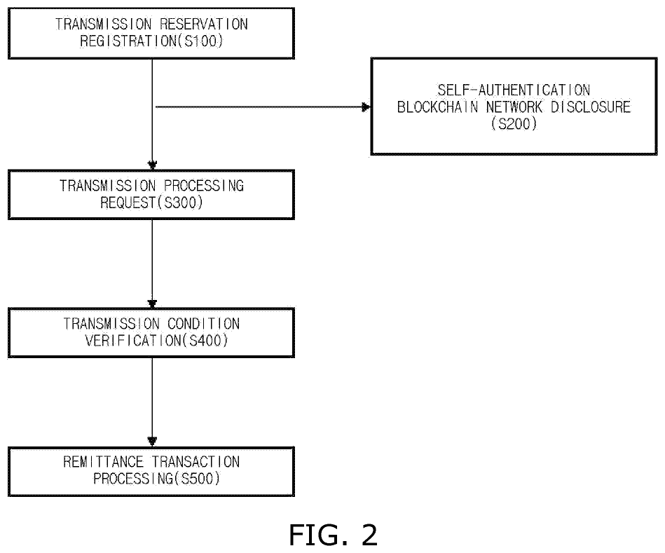

FIG. 1 is a schematic diagram showing the configuration of a system that is applied to a blockchain cryptocurrency transmission method according to an embodiment of the present invention. FIG. 2 is a flowchart showing a blockchain cryptocurrency transmission method according to an embodiment of the present invention.

Referring to FIGS. 1 and 2, the blockchain cryptocurrency transmission method according to the embodiment of the present invention includes a self-authentication blockchain network 200 for self-authentication and a cryptocurrency blockchain network 100 for transmitting cryptocurrency.

The blockchain cryptocurrency transmission method includes a transmission reservation registration step S100 of registering transmission reservation condition information, including a transmission target, a reservation date and time, a transmission amount, and a valid time for a remittance transaction in which real cryptocurrency is transmitted, in the self-authentication blockchain network 200, a broadcasting step S200 of broadcasting the transmission reservation condition information over the self-authentication blockchain network 200, a transmission processing request step S300 of requesting the processing of transmission from the cryptocurrency blockchain network 100 to the self-authentication blockchain network, a transmission condition verification step S400 of verifying transmission conditions using the transmission reservation condition information on the self-authentication blockchain network 200, and a remittance processing step S500 of, when the transmission conditions are valid, processing the remittance transaction on the cryptocurrency blockchain network 100. The transmission reservation condition information may be controlled by a user using a method such as cancelation.

In order to transmit cryptocurrency from blockchain address A 10 to blockchain address B 20, a corresponding action needs to be signed with a private key. However, the private key may be easily duplicated. Although the hardware wallet and the multisig have been currently introduced and used, it has been already mentioned in the Background Art section that they are vulnerable to social engineering attacks utilizing the convenience of use and attacks depending only on encryption keys.

Accordingly, user deception may be drastically reduced by introducing self-authentication into a transmission process. In order for self-authentication to operate stably, a protocol needs to be redesigned to operate at a blockchain address level. This redesign is called a hard fork or a soft fork, and the “soft fork” is a term used to upgrade some functions without changing existing functions. The focus of the present invention is to utilize this to enable self-authentication at a blockchain address level.

When an address is generated on a blockchain, a blockchain address generated using a self-authentication address option operates only as a self-authentication function. In other words, a protocol may be defined and applied such that a withdrawal to another account is made only through a reservation on a blockchain network. In the present invention, such reservation information is registered in the self-authentication blockchain network 200.

When an action not reserved by an actual user is detected while a blockchain reserved by the user is being monitored in the blockchain network 200, it may be canceled or stopped, thereby preventing the unintentional withdrawal of cryptocurrency. The application of the present embodiment can be applied equally to exchange withdrawal work as well as interpersonal transactions.

2. Generation of Self-Authentication Blockchain Address

The self-authenticating blockchain address according to the present embodiment is generated by entering the following options when it is generated.

1. A desired self-authentication blockchain network or desired additional self-authentication blockchain posting network

2. Minimum reservation time

3. A minimum amount

4. The maximum number of usages per month

5. A validity period

6. Emergency transmission address registration

Option No. 1 is to designate a blockchain network that will be used for a self-authentication blockchain address. It may be possible to designate another blockchain network, not the same blockchain network. The reason why multiple blockchain networks can be designated is to prepare for a case where a problem occurs in the same blockchain network and thus the blockchain network cannot be operated.

Option No. 2 refers to the minimum reservation time required to transmit cryptocurrency to the generated blockchain address. The longer the minimum reservation time is, the securer it is, but the ease of use decreases. As a specific example, it is the same as in the case where a final transfer is completed three hours after a request when a predetermined or larger amount is transferred in current financial institutions.

Option No. 3 is introduced to allow for a small amount such as 0.01 bitcoin or less to be transmitted without prior reservation because it is time-efficient to transmit a small amount without prior reservation.

The number of usages per month of option No. 4 may be introduced to prevent multiple transmissions in the minimum amount of option No. 3.

Option No. 5 refers to the period during which reservation details can operate after the transmission reservation time. In the case where the reservation time is 1:00 on the 12th day, when the validity period is set to 30 minutes, remittance may be performed only when a final transmission is made before 1:30.

Option No. 6 is the function of transmitting the remaining amount to the address registered for emergency use upon the generation of the blockchain address when there occurs a problem with the generated address. This may be used when there occurs a problem such as the loss of a user's own private key. A reservation can only be made for a sufficiently long time such as a period ending after at least 3 months. A reservation and a transmission request are made using a generated public key or multi-signature key. When a blockchain address having this function is generated, whether to use a public key or a multi-signature address may be selected.

When selecting an address that operates as a multi-signature, one key can be entrusted to a third party such as an exchange or a bank. Anyone can attempt to obtain a public key when recovering the public key. If the asset is not large, not only will it not be the target of the attack, but it will be re-deposited to your emergency address and option 6 is not required. When an address operating as a multi-signature is selected, one key may be left to a third party such as an exchange or bank. The key to be recovered using a public key may be dangerous because anyone may perform attempt when obtaining the public key. However, if a stored asset is not large, not only are they not subject to attack, but they are re-deposited to his or her own emergency address. Option No. 6 is not essential. The information entered above is recorded on the same blockchain network, and is used as condition data through searching when necessary.

There are two ways to store and use the values generated above. First, the blockchain protocol is redesigned to include the self-authentication address-dedicated option value in the transaction. Second, the redesign of the blockchain protocol is minimized, so that it is stored in an area such as OP RETURN as in the case of Bitcoin, and is then extracted after accessing the storage space with the transaction ID value and used through verification using a newly created script.

Accordingly, specific processes, i.e., the transmission reservation registration step S100, the transmission processing request step S300, the transmission condition verification step S400, and the remittance processing step S500, may be processed within a transaction after the blockchain protocol used in the cryptocurrency blockchain network has been redesigned.

Furthermore, the transmission reservation registration step S100, the transmission processing request step S300, the transmission condition verification step S400, and the remittance processing step S500 are stored in the free storage space of a transaction such as OP RETURN of Bitcoin, and may be extracted and used in accordance with modality as needed.

When transmission to the self-authenticating address is performed, transmission takes place through the following process. In the case of the self-authenticating address, it is checked whether the registered verification conditions are satisfied, and the transmission is performed when there is no abnormality. In the case of Bitcoin, the verification function can be incorporated into the script. Other blockchains have the same script function as Bitcoin, and thus the operation structures thereof are the same.

Blockchains are classified into two types of models according to their state model. There are a UXTO model and an Account model. A representative UTXO model is Bitcoin, and a representative Account model is Ethereum. The above-described generation of a blockchain self-authentication address may be applied to the generation of the smart contract addresses of the UTXO and Account models in the same manner.

In the case of the account model, the storage space and action conditions may be freely set when it is performed in a smart contract manner. More specifically, the transmission reservation registration step, the transmission processing request step, and the transmission condition verification step may be applied and performed. In such a smart contract manner, a multisig activated by a plurality of user keys may be applied.

In the address generation process of the following section “6. Application Example (1),” an actual use case can be found.

3. Transmission Reservation Registration and Disclosure

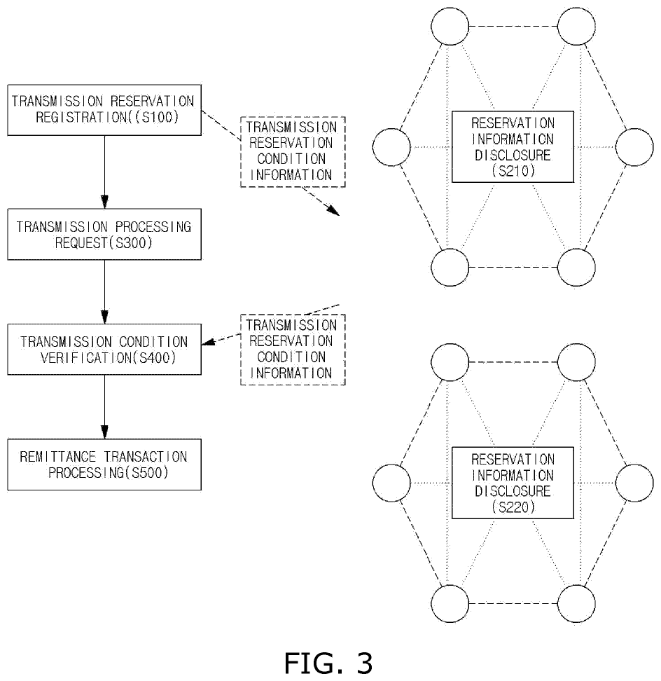

FIG. 3 is a conceptual diagram showing a blockchain cryptocurrency transmission method according to another embodiment of the present invention.

Referring to FIG. 3, it can be seen that there are a plurality of self-authentication blockchain networks, and thus a process in which reservation information is disclosed is performed in a plurality of processes S210 and S220.

The same type of blockchain networks may be applied as the self-authentication blockchain network 200 and the cryptocurrency blockchain network 100. Alternatively, different types of blockchain networks may be applied as the self-authentication blockchain network 200 and the cryptocurrency blockchain network 100, and the self-authentication blockchain network 200 may include a plurality of blockchain networks.

In preparation for a case where the self-authentication blockchain network does not operate, various types of blockchain networks may be used as the self-authentication blockchain networks. As such a blockchain network, various blockchain networks such as Bitcoin, Ethereum, EOS, and private blockchain networks may be applied.

Therefore, by using a plurality of blockchain networks S210 and S220 as the self-authentication blockchain network 200 in which reservation information is disclosed, transmission reservation condition information for self-authentication may be disclosed to several blockchain networks in preparation for a case where one blockchain network does not operate when necessary.

In the reservation registration process of the following section “6. Application Example (2),” an actual use case can be found.

4. Reservation Control of User

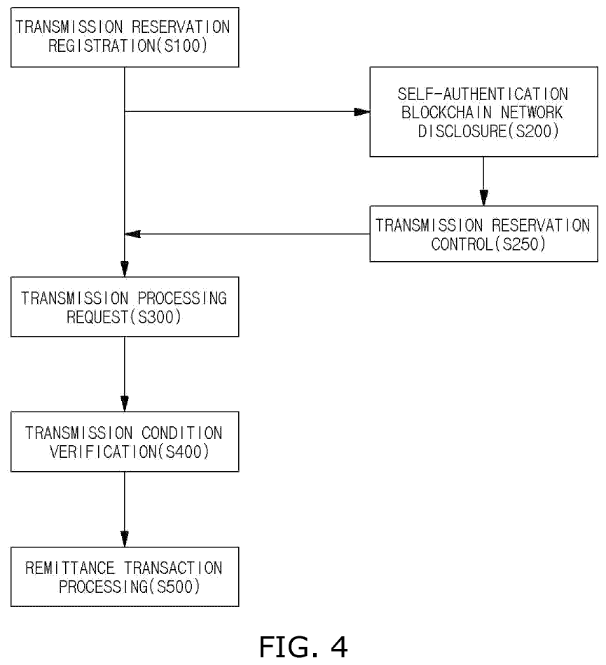

FIG. 4 is a flowchart showing a blockchain cryptocurrency transmission method according to another embodiment of the present invention.

Referring to FIG. 4, the process shown in FIG. 2 further includes transmission reservation control S250. When an action not reserved by a user is detected while a blockchain reserved by an actual user is being monitored in the blockchain network 200, the unintended withdrawal of cryptocurrency may be prevented by canceling or stopping the action at step S250. The present embodiment may be applied to exchange withdrawal work as well as interpersonal transactions.

The transmission reservation control S250 may be controlled by canceling a corresponding remittance transaction, and additionally a temporary stop function may be utilized. When there is an unintended withdrawal while the reservation details of the blockchain network registered by you are being monitored, the following procedure is performed. First, an address temporary stop function is registered. Second, the address is normally used after a temporary stop period.

In this case, variables that can be entered may be 1. a desired period, and 2. the valid time.

Of the above items to be entered for the temporary stop, item No. 1 refers to the total period during which the use of the self-authentication address is stopped. Item No. 2 may determine whether to apply immediately upon registration or choose a starting point.

5. Transmission Condition Verification and Remittance Step

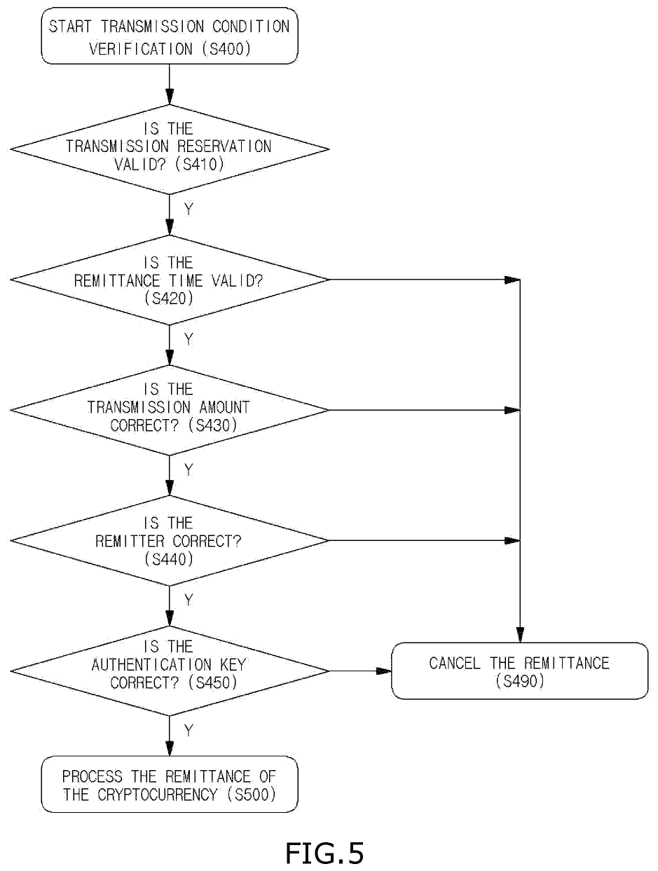

FIG. 5 is a flowchart illustrating transmission condition verification in the blockchain cryptocurrency transmission method according to the embodiment of FIG. 2.

Referring to FIG. 5, conditions for verifying whether transmission conditions are valid at the transmission condition verification step S400 are shown. As described above, since the reservation transmission unintended by a user may be canceled, it is necessary to determine whether the corresponding transmission reservation is valid at step S410. When the validity of the transmission reservation is verified, it is determined whether the current time at which the transmission is requested falls within the transmission period reserved for transmission at step S420. In addition, it is determined whether a transmission amount is correct at step S430 and a remittance subject is correct at step S440. Finally, when a plurality of authentication subjects, such as a multisig, is required, it is checked whether authentication keys set for respective conditions are correct at step S450. The cryptocurrency remittance process is processed only when the above conditions are satisfied at step S500.

6. Application Examples

(1) The generation of a self-authenticating blockchain address complies with the following procedure (an address generation process)

1. A desired blockchain posting network: Ethereum

1-1. An Additional multiple blockchain posting network: EOS

2. Minimum reservation time: 1 hour

3. A minimum amount (unit): 0.5 Bitcoin

4. The number of usages per month: 2

5. A validity period: 30 minutes

6. Emergency transmission address registration: None (2) User A wants to transmit 10 Bitcoins to B, and 3 hours prior to this, user A registered a transmission reservation under the following conditions (a reservation registration process)

1. A self-authentication blockchain network: Ethereum

2. Transmission content: the transmission of 10 Bitcoins to B

3. A reservation date and time: 16th of June, 22:00

4. A transmission amount: 10 Bitcoins

5. Valid time: 1 hour (until 23:00)

(3) After the reservation time, transmission is requested from the Bitcoin network to the self-authenticating address (a final transmission process)

1. Current time: 22:20 on 16th of June

2. Request transmission from the Bitcoin network to the self-authentication address

3. Perform the verification of the above registration conditions in the case of the self-authentication address in the Bitcoin network

3-1. Check whether there is a reservation on the Ethereum network

3-2. Self-authentication address generation conditions and comparison verification in the Bitcoin network

4. Final transmission processing upon the completion of reservation condition verification

### INDUSTRIAL APPLICABILITY

A secondary authentication method is proposed by implementing protection at an address level in an authentication method that technically depends only on a private key. This includes the following industrial applicability.

First, it may possible to reduce private key hacking accidents caused by internal collusion. Second, details of withdrawal may be monitored like an accounting book. Third, it may be possible to reduce the difficulty of managing a private key given to an individual. Fourth, damage can be minimized by offering the opportunity to cancel withdrawal technically.

1. A blockchain cryptocurrency transmission method for transmitting cryptocurrency on a cryptocurrency blockchain network by using a self-authentication blockchain network for self-authentication and the cryptocurrency blockchain network for transmission of cryptocurrency, the blockchain cryptocurrency transmission method comprising:
a transmission reservation registration step of registering transmission reservation condition information, including a transmission target, a reservation date and time, a transmission amount, and a valid time for a remittance transaction in which real cryptocurrency is transmitted, in the self-authentication blockchain network;
a transmission processing request step of requesting processing of transmission from the cryptocurrency blockchain network to the self-authentication blockchain network;
a transmission condition verification step of verifying transmission conditions using the transmission reservation condition information on the self-authentication blockchain network; and
a remittance processing step of, when the transmission conditions are valid, processing the remittance transaction on the cryptocurrency blockchain network;
wherein the transmission reservation condition information is controllable by a user.

2. The blockchain cryptocurrency transmission method of claim 1, wherein the self-authentication blockchain network and the cryptocurrency blockchain network are a same type of blockchain networks.

3. The blockchain cryptocurrency transmission method of claim 1, wherein the self-authentication blockchain network and the cryptocurrency blockchain network are different types of blockchain networks.

4. The blockchain cryptocurrency transmission method of claim 3, wherein the self-authentication blockchain network includes a plurality of blockchain networks.

5. The blockchain cryptocurrency transmission method of claim 1, wherein the transmission reservation condition information registered at the transmission reservation registration step is inquired only by an owner of the cryptocurrency.

6. The blockchain cryptocurrency transmission method of claim 1, wherein the transmission reservation registration step, the transmission processing request step, and the transmission condition verification step are performed by a smart contract.

7. The blockchain cryptocurrency transmission method of claim 6, wherein a multisig configured to be activated by a plurality of user keys is applied to the smart contract.

8. The blockchain cryptocurrency transmission method of claim 1, wherein an emergency transmission function of transmitting a remaining amount to a registered emergency transmission address when a problem occurs during a remittance process is provided.

9. The blockchain cryptocurrency transmission method of claim 1, wherein controlling the transmission reservation condition information by the user comprises canceling the remittance transaction corresponding to the transmission reservation condition information.

10. The blockchain cryptocurrency transmission method of claim 1, wherein the transmission reservation registration step, the transmission processing request step, the transmission condition verification step, and the remittance processing step are processed within the transaction by redesigning a blockchain protocol used in the cryptocurrency blockchain network.

11. The blockchain cryptocurrency transmission method of claim 1, wherein an operation protocol of the transmission reservation registration step, the transmission processing request step, the transmission condition verification step, and the remittance processing step is stored in a free storage space for the transaction to minimize protocol redesign and is extracted and used in accordance with modality.
